(19) United States
(12) Patent Application Publication
(10) Pub. No.: US 2015/0226186 A1
(43) Pub. Date: Aug. 13, 2015

(54) ELASTIC SELF-ALIGNING BEARING

(71) Applicant: ESM ENERGIE-UND SCHWINGUNGSTECHNIK MITSCH GMBH, Rimbach-Mitlechtern (DE)

(72) Inventors: Franz Mitsch, Heppenheim (DE); Sebastian Glanzner, Lorsch (DE); Karl-Heinz Hanus, Morlenbach (DE)

(73) Assignee: ESM ENERGIE-UND SCHWINGUNGSTECHNIK MITSCH GMBH, Rimbach-Mitlechtern (DE)

(21) Appl. No.: 14/426,588

(22) PCT Filed: Sep. 7, 2013
(86) PCT No.: PCT/EP2013/002688

§ 371 Date: Mar. 6, 2015

(30) Foreign Application Priority Data
Sep. 13, 2012 (EP) 12006429.0

(51) Int. Cl. F03D 11/00; F16C 27/02; F16C 27/06; F03D 1/06

(52) U.S. Cl. CPC F03D 11/0008; F03D 1/0658; F16C 27/02; F16C 27/063

(57) ABSTRACT

A teeter bearing, preferably for use in wind turbines, which is built up from elastic, in particular conical multilayered spring elements, which can optionally be varied in their stiffness behaviour by hydraulic devices and are arranged constructively in the region of the rotor hub so that they are consequently highly suitable both for adjustment of the rotor blades and also for reduction of undesired forces transmitted to the turbine through the rotor blades. In particular, the teeter bearings are suitable for use in one- and two-bladed rotor wind turbines.

This application is a National Stage completion of PCT/EP2013/002688 filed Sep. 7, 2013, which claims priority from European patent application serial no. 12006429.0 filed Sep. 13, 2012.

### FIELD OF THE INVENTION

The invention relates to a teeter bearing which is built up from elastic, in particular conical, but also cylindrical ellipsoidal multilayered spring elements, which can optionally be varied in their stiffness behaviour by hydraulic devices and are arranged constructively in the region of the rotor hub or main shaft of the wind turbine. Bearings of this type are consequently suitable both for adjustment of the rotor blades and also for reduction of undesired forces transmitted to the turbine through the rotor blades. The teeter bearings according to the invention are suitable for use in one-, two- or multibladed rotor wind turbines, preferably in turbines driven by a two-bladed rotor. However, the teeter bearings according to the invention are also for use in clutches and in drive trains in ships and helicopters.

### BACKGROUND OF THE INVENTION

In wind energy turbines, in particular those which use 2-bladed rotors instead of the conventional 3-bladed rotors, teeter bearings are often employed in order to reduce or eliminate the forces and moments from the wind loads on the drive train. Whereas unequal mass moments of inertia caused by the action of wind can be controlled well in three-bladed rotor systems through the uniform geometrical distribution of the rotor blades and only occur in extreme situations, this problem is ubiquitous in two-bladed rotor turbines.

The way in which corresponding wind loads can act on such turbines is shown diagrammatically by FIG. 1. Thus, for example, the wind force on one rotor blade may be significantly greater than on the other opposite blade, which is not a rare occurrence when the rotor blades of large wind turbines with high towers and large rotor diameter pass through the vertical, since the wind usually blows more strongly at greater height than in the vicinity of the ground (FIG. 1, left-hand picture). However, unequal wind forces on the two-bladed rotor system also easily occur if the wind blows from the side and the rotor is just passing through the horizontal (FIG. 1, right-hand picture). In both cases, unequally distributed mass moments of inertia occur, which are inevitably transferred to the tower and the turbine as a whole and can thus result in a reduced service life of individual components or even in spontaneous damage.

In accordance with the prior art, correspondingly arranged conical bearings, which function as teeter bearings, are often employed in the region of the main shaft and rotor system for a problem of this type, where the wind loads, which act unequally or indirectly on the rotor blades, are reduced by the flexibility and elasticity of the bearing under load.

Owing to the objectives described and functions required, large conical bearings are usually employed as teeter bearings. However, as turbines become ever larger, it becomes ever more difficult to vulcanise and produce such large conical bearings from one piece. In addition, it is complex and difficult to pretension these large conical bearings. Moreover, replacement of such a large and heavy conical bearing when necessary is very complex, since the rotor hub generally firstly has to be fixed in order to be able to remove the conical bearing. Furthermore, it is not simple to change or vary the cone angle of a bearing of this type in order to obtain more flexibility in relation to the overall design situation of the system and the possible wind actions occurring. On replacement of these bearings and substitution by bearings having a different cone angle, it is, in addition, generally necessary to produce and provide other vulcanisation tool which have been correspondingly adapted.

SUMMARY OF THE INVENTION

The object was thus to provide a bearing for the purposes described, in particular for use in wind turbines and preferably for use in turbines having two-bladed rotors, which does not have the disadvantageous properties of the previous technical solutions to this problem, and in addition enables more flexibility in the fine tuning and adjustment of the rotor blades, in particular in a two-bladed rotor system.

The object has been achieved in accordance with the invention by novel teeter bearings corresponding to the claims and the following description.

The teeter bearings according to the invention have to ensure the following functions:

ability of the rotor blades (5) to rotate about the teeter shaft (3) transfer of the drive moment around the axis of the main shaft (1) absorption of the axial forces (F1) and radial forces (F2 and F3) from prevailing wind loads and rotor weight.

### BRIEF DESCRIPTION OF THE DRAWINGS

FIG. 1: shows possible wind action forces on the two-bladed rotor of a wind turbine.

FIG. 2: shows the use of teeter bearings according to the invention in the region of the rotor hub/main shaft of a two-bladed rotor wind turbine (plan view and cross section) without additional hydraulic devices.

FIG. 3: shows the use of teeter bearings according to the invention in the region of the rotor hub/main shaft of a two-bladed rotor wind turbine (plan view and cross section) with additional hydraulic devices.

FIG. 4-7: show diverse suitable multilayered springs (4) and their arrangement in the teeter bearings (9) according to the invention

FIG. 8: shows a 3-D representation of an embodiment of a teeter bearing according to the invention, in which the multilayered spring elements (4) are provided with tensioning devices, before mounting in the bearing housing.

FIG. 9: shows a 3-D representation of an embodiment of a teeter bearing according to the invention, in which the multilayered spring elements (4) are provided with tensioning devices, after mounting in the bearing housing and thus after pretensioning.

FIG. 10: shows an embodiment of an inner stop of a layer element (4)

FIG. 11: shows the use of a teeter bearing according to the invention in a wind turbine having three rotor blades, where the teeter bearing is mounted on the main shaft (1) here.

FIG. 12: shows possible arrangements (a-c) of the multilayered spring elements (4) of the teeter bearing according to the invention on the main shaft (1) (of a wind turbine).

FIG. 13: shows the arrangement of a teeter bearing according to the invention in a 1-bladed wind turbine.

FIG. 14: shows a multilayered spring element arrangement (4) according to the invention having a cavity which can be filled hydraulically, optionally via a pressure accumulator.

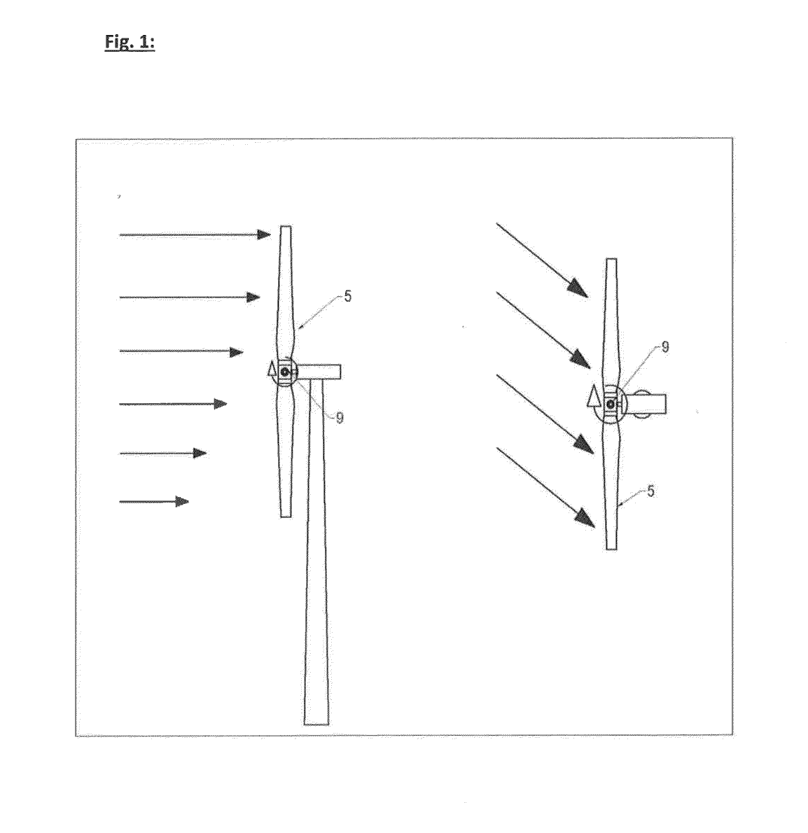

### DETAILED DESCRIPTION OF THE PREFERRED EMBODIMENTS

The invention was based on the original idea of using a plurality of bearings originating from individual parts of a large conical bearing instead of a complete conical bearing known per se built up from a plurality of elastic layers. A bearing of this type is consequently simpler to produce, since less rubber volume is required for the vulcanisation process. Due to the lower weight and the smaller dimensions, handling of the individual parts is better. The individual parts can now be pretensioned more easily and with a fraction of the force compared with the complete large conical bearing. Replacement is simpler since the parts can be removed and replaced individually without the need for complete disassembly of the rotor (5) and rotor hub (8). Individual parts give rise to cost savings, e.g. due to smaller metal sheets, simpler manufacture and smaller rubber volumes.

It has now been found that even the cone segments of an originally large conical bearing built up from a plurality of elastic and non-elastic layers can be replaced by correspondingly shaped elastic elements in which the elastic and non-elastic layers are themselves not conical, but instead planar or flat. However, simple division of the complete conical bearing reduces the service life of the individual parts. In order to increase the service life again, these individual parts are now designed in accordance with the invention as round multilayered springs. Round multilayered springs have smaller extensibilities than rectangular springs and have more than twice the service life. The multilayered springs, which are thus flat and preferably round, now have to be accommodated in accordance with the invention in a changed geometry which has now become necessary in the rotor/main shaft region, compared with a standard conical bearing having conical layers.

In a particular embodiment, the individual elastic (and non-elastic), preferably round layers of the multilayered spring have different sizes, and thus when joined together form a conical multilayered spring.

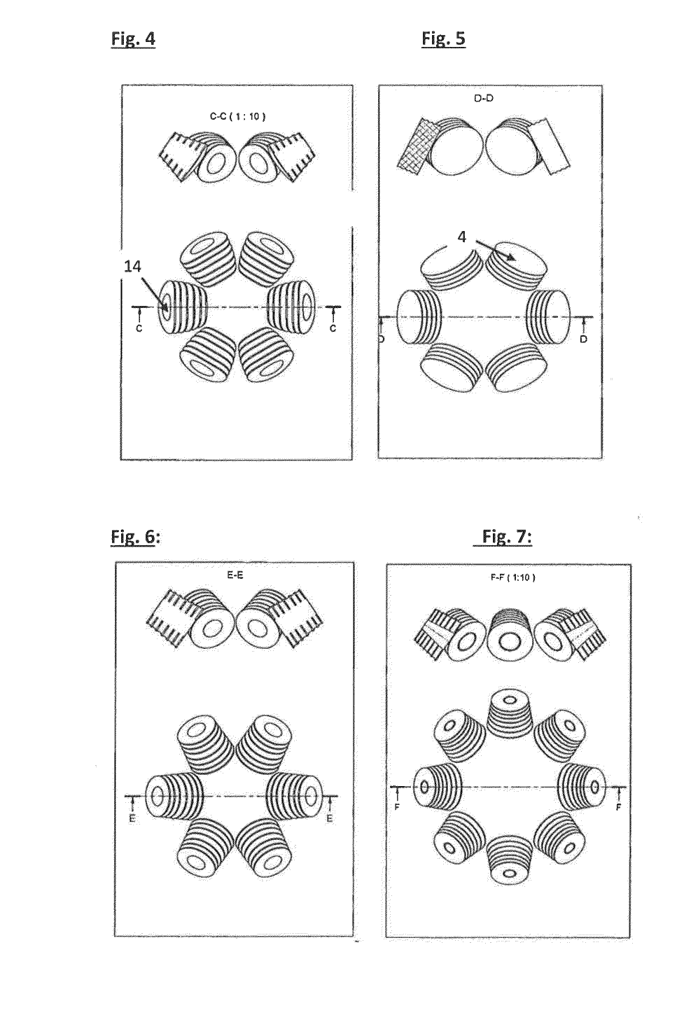

In further embodiments of the multilayered springs having an improved service life which are employed in the teeter bearing according to the invention, these can be designed in further various shapes. Surprisingly, it has been found that corresponding multilayered springs have twice to four times the life expectancy compared with round multilayered springs having a cylindrical design (when used as described in the teeter bearings according to the invention) if they have an elliptical base shape. The conically shaped multilayered springs described above (comprising round, flat layers) exhibit an increased service life within the teeter bearings according to the invention compared with the cylindrically round multilayered springs, but a shorter service life compared with multilayered springs having an elliptical base shape. The individual types of multilayered spring which can be used in the teeter bearings according to the invention are depicted in FIGS. 4-7.

The teeter bearings according to the invention are based on the types of multilayered spring known per se that are described above. It is also possible to employ innovative multilayered springs, as, for example, in WO 2011/088965. However, the teeter bearings according to the invention achieve their superiority from these multilayered springs in combination with the special geometry of the functional design elements in the region of the rotor of the wind turbine.

The invention accordingly relates to a teeter bearing (9) comprising an inner bushing (10), which is able to accommodate the teeter shaft (3) for the teeter bearing, and a surrounding outer bushing (11), which is connected to the inner bushing (10) and comprises tensionable elastic elements (4) in the form of multilayered springs which are built up from flat, elastic layers and flat, non-elastic interlayers, where the elastic elements used are at least four, preferably four to eight, multilayered springs (4) having a round or elliptical base shape. Said elastic elements (4) in the interior of the outer bushing (11) are arranged in a radial distribution around the inner bushing (10) and have tensioning devices (12) which tension the outer and inner bushings against one another via the multilayered springs (4). The tensioning thus enables the thickness of the elastic multilayered springs and thus the pretensioning to be adjusted and changed to the respective regions of the inner bushing and thus of the teeter shaft independently of one another.

The invention also relates, in particular, to a corresponding teeter bearing in which the said multilayered springs (4) are conical, where, in a particularly suitable embodiment, the broader cone surfaces of the multilayered springs (4) face in the direction of the inner bushing carrying the teeter shaft (3), and the narrower surfaces face outwards. The conical multilayered springs used within the bearings according to the invention can be regarded as a good compromise between sufficiently long service life and economically acceptable manufacturing costs.

The invention relates, in particular, to a corresponding teeter bearing in which the said multilayered springs (4) are cylindrically ellipsoidal, since here, as already outlined, in combination with their special arrangement in the teeter bearing according to the invention, they surprisingly prove to be particularly resistant to wear caused by the generally large forces acting on the bearing. These multilayered springs thus prove to be particularly robust on use in the bearings according to the invention, but are more complex and thus more expensive to manufacture.

However, the invention relates to a corresponding teeter bearing which has cylindrically round multilayered springs (4), since these are very simple and inexpensive to manufacture. Such bearings are the means of choice in turbines in which unequal mass moments of inertia which are not particularly large occur.

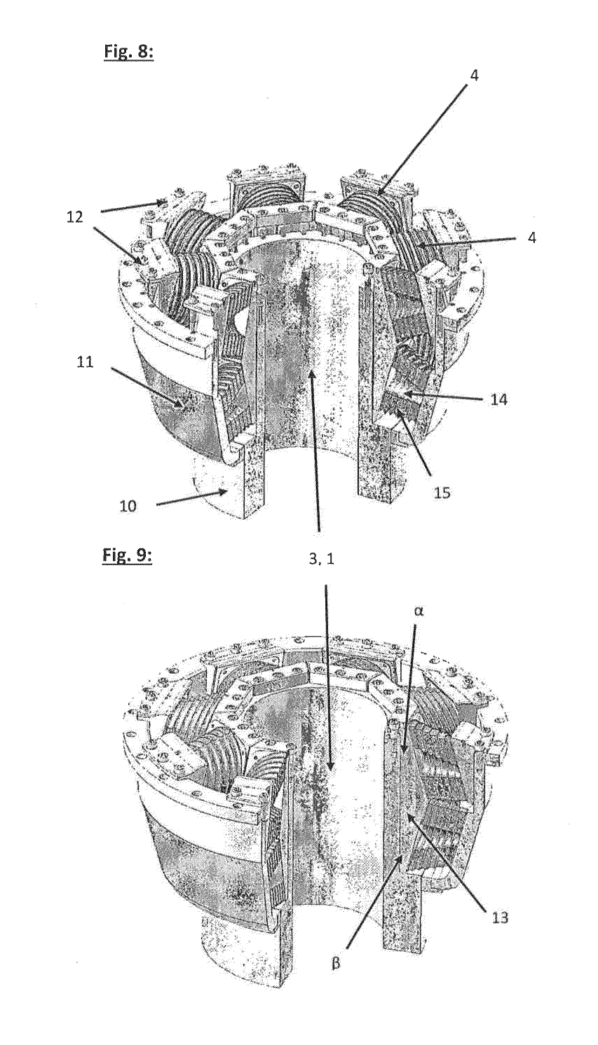

The multilayered spring elements (4) are, in accordance with the invention, provided with tensioning devices (12) which enable the multilayered springs to be tensioned between outer bushing (11) and inner bushing (10), which also achieves an adjustable pretension. The tensioning devices—these are generally bolted connections or clamped retainers—are preferably installed on both base surfaces of the multilayered springs (4) owing to the requisite geometrical arrangement. However, other attachment means or tensioning devices are also possible at other positions in the teeter bearing according to the invention. FIGS. 8 and 9 show an embodiment of the teeter bearing (9) according to the invention in the untensioned (FIG. 8) and pretensioned (FIG. 9) state. The invention thus relates to a corresponding teeter bearing in which each multilayered spring is provided on both faces or base surfaces with tensioning device parts (12) which are arranged with a close fit between the inside wall of the outer bushing (11) and the outside wall of the inner bushing (10) carrying the teeter shaft (3).

By means of the said multilayered springs, the pitch of the elastomeric element (4) angle relative to the teeter shaft can be changed, enabling the axial and radial stiffness of the element and thus of the entire teeter bearing to be influenced. The change in the pitch relative to the teeter shaft can be carried out, for example, via corresponding angle pieces (13). This or other measures enable the angle (α, β) between multilayered spring element (4) and the teeter shaft to be adjusted to any value from 0° to 45°, preferably between 0° and 30°.

The possibility of not only individually pretensioning individual elastomer elements or groups of elastomer elements, but also adjusting them individually in relation to the tilt to the teeter shaft (3) gives the teeter bearing according to the invention properties which can be matched in a flexible manner to the nature of the turbine, the location and the wind conditions prevailing there. In particular, specific changes to the rotor blade angles can be achieved thereby.

This includes not only the possibility of individually regulating the stiffness of the teeter bearing mechanically through the said tensioning devices, but also influencing it in a reversible manner by hydraulic means after the pretension has been set mechanically. To this end, one or more or all multilayered spring elements (4) of the teeter bearing according to the invention have a hydraulic element (14), into which a compressible gas or a hydraulic fluid can be forced, enabling the stiffness of the bearing or in parts of the bearing to be increased or if desired reduced. In an embodiment, the hydraulic element (14) is a hollow volume, which may have different sizes, in the core of the multilayered spring (4). All types of multilayered spring known to date can thus be designed as hydraulic multilayered springs (4). This makes it possible to integrate active blade adjustment into the teeter bearings according to the invention. The hydraulic elements (14) are connected to hydraulic lines (6) and are controlled means of a hydraulic pump (7) connected in between. In order to carry out a twist of the rotor blades with the aid of the hydraulic elements, the fluid is pumped from one spring (4) into the other, making one spring (4) larger in terms of volume and the other smaller. Instead of a hydraulic pump (7), it is also possible to use thrust cylinders, which load one or more springs, for the adjustment. The hydraulic blade adjustment rotates the entire rotor hub (8) and thus one rotor blade (5) into the wind and the other (in the case of a two-bladed rotor turbine) out of the wind. This adjustment enables the loads due to unfavourable wind conditions to be reduced even further. Only a relatively small angle (α, β) is required for this purpose.

The invention thus relates to a corresponding teeter bearing in which at least one multilayered spring (4) has a hydraulic element (14), into which a gas or a fluid is forced in or out by a hydraulic devices (6, 7) and means, enabling the stiffness of the bearing and thus the setting of the rotor blades (5) or the mass moment of inertia onto the turbine to be changed. The hydraulic element (14) is preferably a hollow volume, so that the corresponding elastic layer elements (4) are designed as hollow rubber springs, which are simple to produce and in addition are relatively soft.

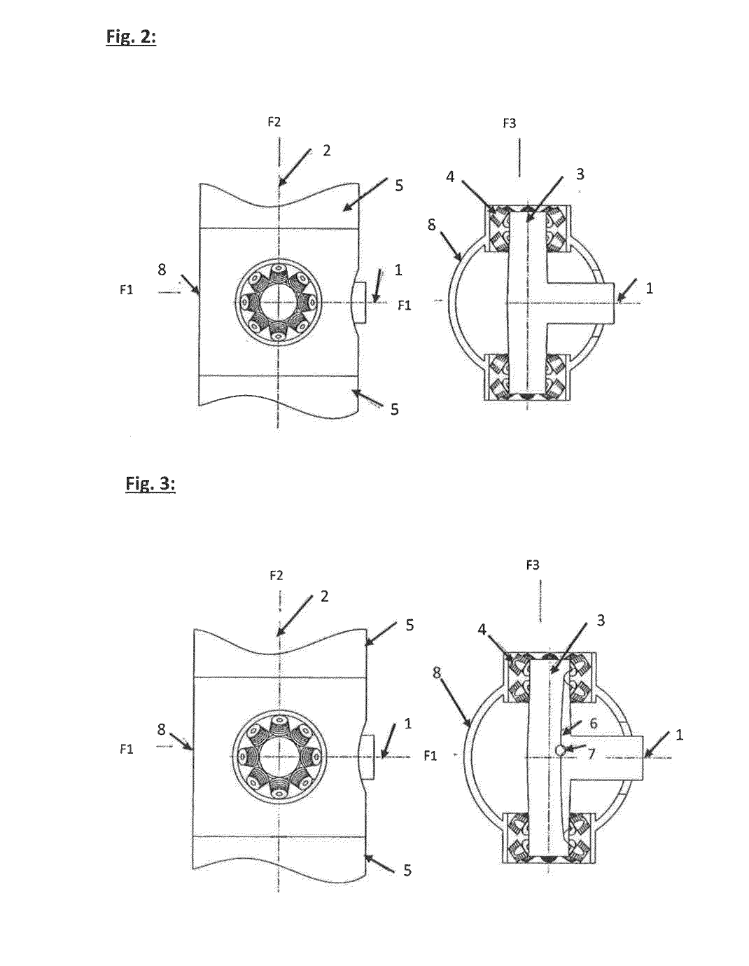

The teeter bearing according to the invention is, as already mentioned, installed in the region of the rotor, the rotor hub or the main shaft in accordance with the design features and circumstances of the respective turbine. In accordance with the invention, at least one, but preferably at least two of the teeter bearings according to the invention are employed for a turbine, preferably in the region of the rotor hub, or as integral constituent thereof. FIG. 2 and FIG. 3 show a corresponding arrangement of two functionally cooperating teeter bearings in accordance with the invention in their constructive environment to the main drive shaft (1) and to the rotor hub element (8), where the main shaft (1) is connected at its tip to the teeter shaft (3), arranged perpendicular thereto, which has a teeter bearing (9) according to the invention at each of its two opposite ends and is built into the rotor hub element (8) or is an integral constituent thereof. The figures show the possible design for a two-bladed rotor turbine,

The subject-matter is thus a corresponding teeter bearing in which the inner bushing (10) is formed by at least one terminal region of the shaft (3), which is connected to the outer bushing (11) via said layer elements (4). The inner bushing should thus be regarded as an integral constituent of the teeter shaft (3), which takes on the function of the inner bushing. Teeter shaft (3) and main shaft (1) in this case form a T-piece, to the two ends of which the teeter bearing (9) is attached. Alternatively, the inner bushing (10) may also be pushed separately onto end of the shaft (3) (preferably on both sides) and fixed.

However, the subject-matter is also a corresponding teeter bearing in which the inner bushing (10) is formed by the terminal region of the main shaft (1), which is connected to the outer bushing (11) via said layer elements (4). The inner bushing should thus be regarded as an integral constituent of the main shaft (1), which takes on the function of the inner bushing. The use of a T-piece, as described above, is thus superfluous. Alternatively, the inner bushing (10) may also be pushed separately onto the end of the shaft (1) and fixed. The outer bushing (11) can in this case be formed by the rotor hub.

The invention thus likewise relates to a rotor hub (8), preferably for a one-, two- or optionally three-bladed rotor in a wind turbine, which, besides the devices for fixing for the one, two (or more) rotor blades, has a teeter shaft (3), to at least one end of which a teeter bearing (9), as specified above and in the claims, is attached and has direct or indirect connection and fixing means for the main drive shaft (1) of the rotor, where the teeter bearing(s) are permanently connected constructively to the rotor hub (8) or the carrier part thereof (housing) or integrated into this. The rotor hub (8) according to the invention comprises, in particular, a teeter bearing, as described above and below, fixing devices for the rotor blades, and fixing devices for the shaft (3) or the shaft (1).

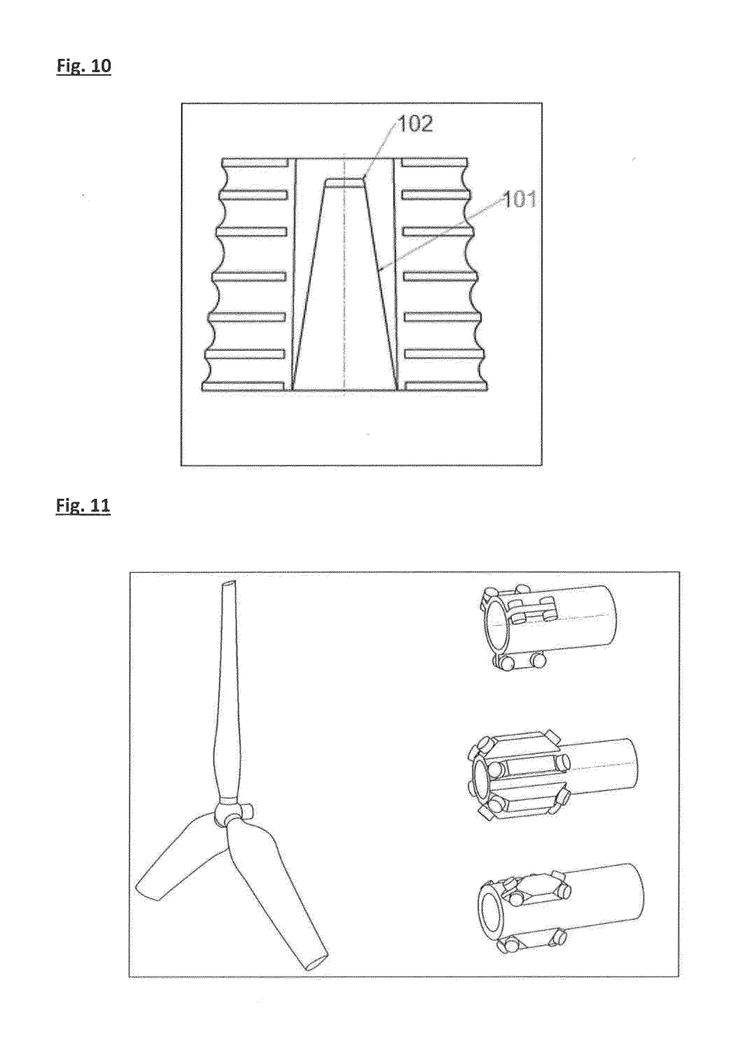

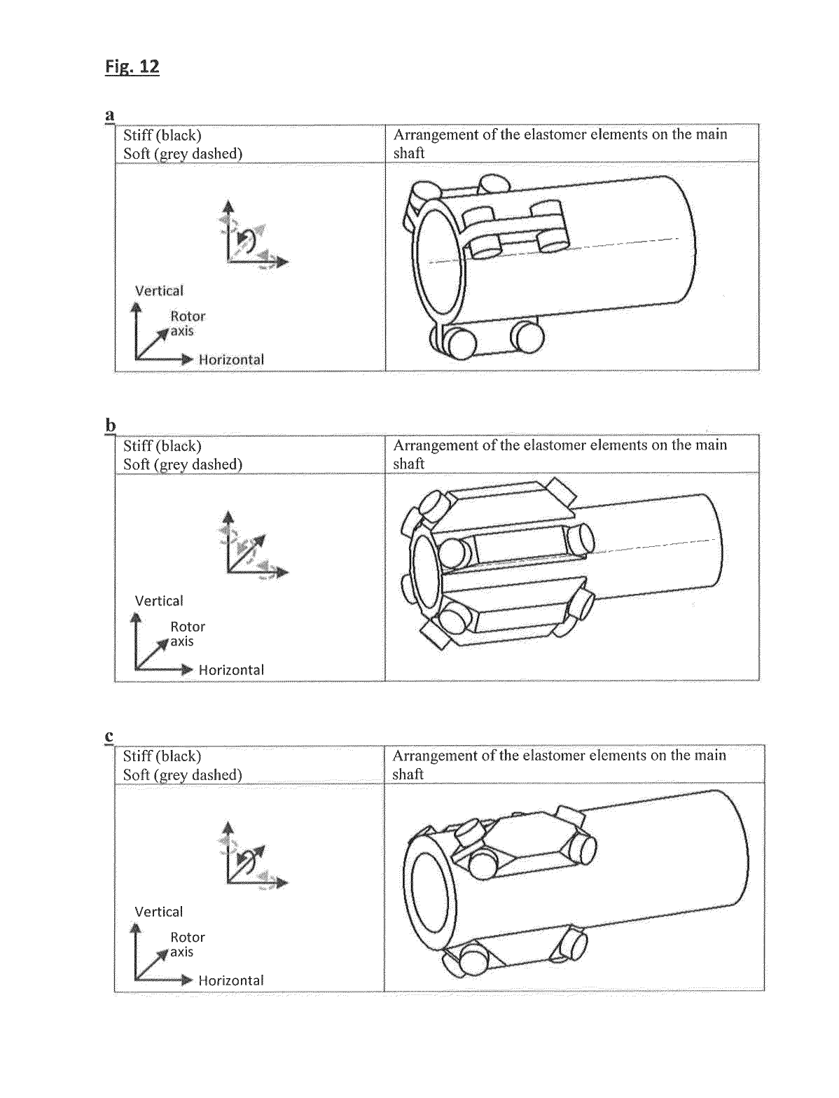

In the case of a three-bladed rotor turbine, the arrangement of the teeter bearings according to the invention should be adapted correspondingly. Embodiments according to the invention are described in FIGS. 11 and 12.

The teeter bearings according to the invention are, as already explained, eminently suitable for achieving a reduction, elimination and control of, in particular, undesired unequal mass moments of inertia which are transmitted due to the wind from the rotor blades (5) to the tower of a wind turbine. They also enable the specific adjustment of individual or all rotor blades.

However, the teeter bearings according to the invention are furthermore also for use in clutches in machines, or in drive trains for helicopters and ship's drives in combination with rotor and ship's propeller devices.

The invention thus relates to the use of a corresponding teeter bearing (9) for the reduction, elimination and control of mass moments of inertia which are transmitted from the rotor blades (5), for example, to the tower of a two-bladed rotor or three-bladed rotor wind turbine, preferably a two-bladed rotor turbine, and for the adjustment of rotor blades (5) of a corresponding wind turbine, where at least two such bearings are arranged in the region of the rotor hub (8).

The invention also relates to the use of a corresponding teeter bearing for the adjustment of rotor blades or for the reduction, elimination and control of mass moments of inertia which are transmitted from the rotor blades of a one-, two- or multibladed wind turbine or of a helicopter or of a ship's propeller.

It may be necessary in extreme situations to limit the deformation of the elastomer elements (4). In order to limit the maximum axial and radial deformation of the elastomer element (4), a metal stop (101) can be incorporated in the interior (FIG. 10). From a certain radial deformation, the inner surface of the elastomer layers touches the metal stop (101). As soon as an elastomer layer touches the metal stop (101), it becomes very much stiffer, which results in the desired delimitation of the radial deformation. Due to the conical design of the metal stop (101), the individual elastomer layers only come into contact one after the other. As a consequence, the radial stiffness of the entire elastomer element (4) increases more slowly with increasing radial deformation, and a sudden increase does not occur. From a certain axial deformation, the elastomer element (4) comes into contact with the upper part of the metal stop (101). This causes the axial stiffness of the elastomer element (4) to increase. In order to prevent a sudden increase in the axial stiffness, a cushioning layer (102) is provided on the upper part of the metal stop (101). With increasing axial deformation, the upper cushioning layer (102) compresses and becomes stiffer, which results in the desired delimitation of the axial deformation. The invention thus also relates to a corresponding teeter bearing which has one or more multilayered spring elements (4) which have in their interior, optionally hollow interior, a fixed stop in the form of a cylinder or cone body, which is preferably arranged perpendicular to the layers. It is likewise possible to cover the entire metal stop (101) with a continuous thick elastomer layer.

The stop for delimitation of the radial deformation can also be facilitated by at least two hydraulic elastomer elements which act radially to the elastomer elements (4) of the teeter bearing (9). The elements act tangentially in the peripheral direction of the teeter bearing (9) (see FIG. 15). The internal hydraulic volume (105) of the hydraulic elastomer element may, as depicted in FIG. 15, be connected to a pressure control valve (103) on a pressure accumulator (104). In the case of a very large rotation of the teeter bearing (9) around the teeter bearing shaft (3), the hydraulic elastomer element compresses. The external deformation allows the pressure in the internal hydraulic volume (105) to increase until the pressure control valve (103) opens. On further deformation, the fluid flows through the pressure control valve (103), which is now open, into the pressure accumulator (104). The pressure in the fluid can then no longer increase, since the fluid escapes into the pressure accumulator (104). The spring force consequently increases only a little with further deformation. From a certain deformation, the pressure accumulator (104) is completely filled with fluid, and the characteristic line becomes progressive again, since the fluid can no longer flow out of the hydraulic elastomer element (4) into the pressure accumulator (104). This long flat force/path characteristic line limits the possible stop force even in the case of a large deformation. This has a positive effect on all connection parts, since they they can be designed with smaller dimensions.

Further embodiments of the invention are shown by FIG. 12 (a-c) The first possibility of the arrangement consists in a type of claw clutch. In this arrangement, the elastomer elements (4) are subjected to shear stress in the case of pitch and yaw rotations and thus react very softly. Due to this elasticity, the bending moments from pitch and yaw rotations are reduced. The elastomer elements (4) are subjected to compression stress in the direction of rotation to the axis of rotation of the main shaft (1) and react stiffly. The arrangement is stiff in the horizontal and vertical direction (both radial to the main shaft (1)), while the arrangement is soft in the direction of the main shaft (1).

The elastomer elements (4) can also be arranged in the form of a sphere. This results in all radial and axial deformations of the teeter bearing (9) being stiff, while all rotation directions (pitch, yaw and rotor rotation) are soft. This arrangement is similar to a classical ball joint. It is positive that the pitch and yaw movements are soft. It is not positive that the rotation direction around the main shaft (1) is likewise soft.

A combination of the two arrangements mentioned above is depicted in FIG. 12c, Here, the elastomer elements (4) are oriented in such a way that they are subjected to shear stress in the case of pitch and yaw movements, so that they react softly. In the other directions, the elastomer elements are principally subjected to compression stress and react more stiffly. This also applies to rotation around the main shaft (1), which is now likewise stiff. This arrangement is ideal and combines the advantages of the two previous arrangements.

The above-mentioned arrangements 12 (a-c) can be employed not only in relation to the main shaft (1), but can also be applied in principle to the teeter shaft (3), which is connected to the main shaft (1) as T-shaped part.

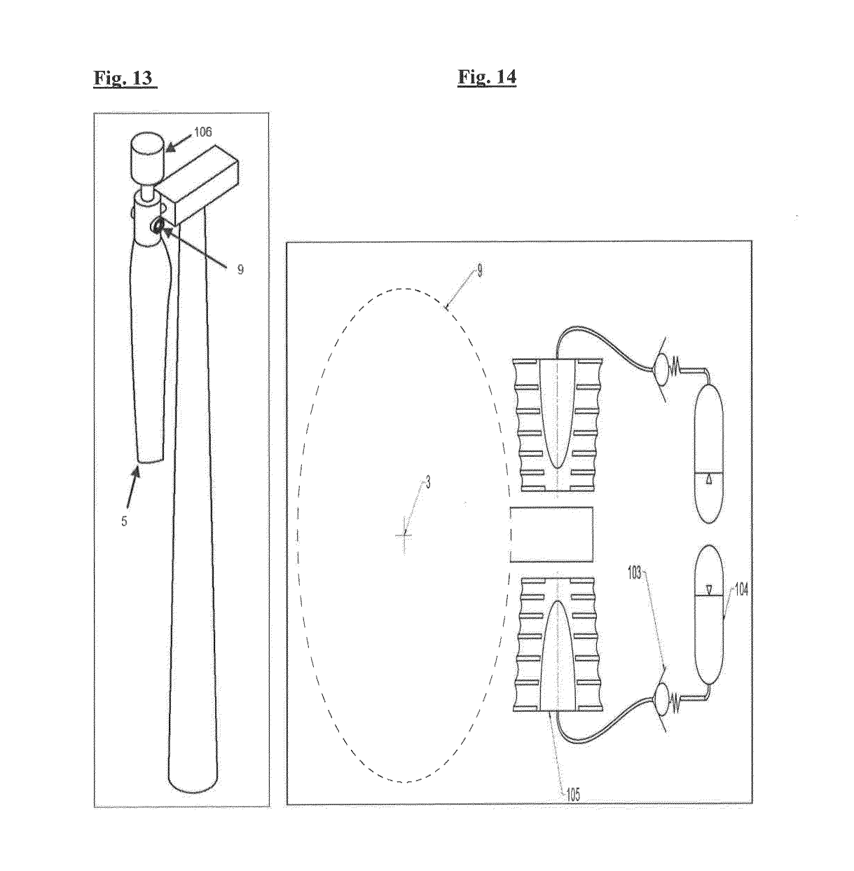

FIG. 13 shows by way of example the use of the teeter bearing (9) in a wind turbine having only one rotor blade (5). In order to reduce the imbalance, a wind turbine of this type always has a counterweight (106). The non-uniform wind force, between rotor blade (5) and counterweight (106), causes very high dynamic bending moments in the case of a rigid connection of rotor and nacelle. As also in the case of the two-bladed rotor, it is also necessary here to allow the rotor blade (5) to teeter in order to reduce the bending moments. The teeter bearing (9) and the elastomer elements (4), have the same construction here as in the case of a two-bladed rotor,

The teeter bearing according to the invention can also be employed as clutch in other machines, in particular if an axial load and a torque have to be transmitted with high stiffness, at the same time as cardanic softness with large cardanic inclinations. This is not only the case in wind turbines, but also, for example, in the drive train of ships or helicopters.

The diameters and thicknesses of the individual layers of an individual spring (4) can be identical or different from layer to layer. Depending on the type of load, it can be ensured, through different layers, that each layer has approximately the same service life. It is thus ensured that the springs achieves the maximum service life without one layer being overloaded and another layer hardly being loaded at all. The multilayered springs (4) of the teeter bearing (9) according to the invention essentially consist of a natural rubber, a natural rubber derivative or of a suitable elastic polymeric plastic or plastic mixture. The elastomer layer may in accordance with the invention have different hardness (“Shore hardness”) and different damping properties, corresponding to the desired requirements. Elastomers having a hardness of 20 to 100 Shore A, in particular 30 to 80 Shore A, are preferably used. The preparation of such elastomers of different hardness is known in the prior art and adequately described in the relevant literature. Commercially available natural rubbers or plastics are preferably employed. The non-elastomeric layers are preferably intermediate plates made from substantially non-elastic materials having low compressibility. These are preferably metal sheets, but it is also possible to employ other materials, such as hard plastics, composite materials or carbon-fibre-containing materials,

Brief description of the reference numerals used and the FIGS.
(1) Main shaft
(2) Rotor blade axis/
(3) Teeter bearing shaft/shaft for teeter bearing
(4) (Hydraulic) elastomer element
(5) Rotor blade
(6) Hydraulic lines
(7) Hydraulic pump
(8) Rotor hub
(9) Teeter bearing
(10) Inner bushing
(11) Outer bushing
(12) Tensioning device elements
(13) Angle part
(14) Hydraulic element/hollow volume in the interior of the multilayered spring element (4)
(15) Hollow rubber multilayered spring
α, β Angles of the angle element (13) to the teeter shaft (3)
101 Metal stop
102 Rubber cushion
103 Pressure control valve
104 Pressure accumulator
105 Hydraulic volume
106 Counterweight

1-20. (canceled)

21. A teeter bearing (9) comprising:
an inner bushing (10), which is able to accommodate the shaft or teeter shaft (3) or the main shaft for the teeter bearing, and
a surrounding outer bushing (11), which is connected to the inner bushing (10) and comprises tensionable elastic elements (4) which are built up from elastic layers and non-elastic interlayers,
wherein the elastic elements used are at least four multilayered springs (4) having a round or elliptical base shape, where the elastic elements (4) in the interior of the outer bushing (11) are arranged in a radial distribution around the inner bushing (10) and have tensioning devices (12), enabling the thickness of the elastic multilayered springs, and thus the pretensioning, to be adjusted and changed to the respective regions of the inner bushing and thus of the teeter shaft independently of one another.

22. The teeter bearing according to claim 21, wherein the multilayered springs (4) are conical.

23. The teeter bearing according to claim 22, wherein a broader cone surface of the multilayered springs (4) faces in a direction of the inner bushing carrying the teeter shaft (3).

24. The teeter bearing according to claim 21, wherein the multilayered springs (4) are cylindrically ellipsoidal.

25. The teeter bearing according to claim 21, wherein the multilayered springs (4) are cylindrically round.

26. The teeter bearing according to claim 21, wherein each multilayered spring is provided, on both faces, with tensioning device parts (12) which are arranged with a close fit between the inside wall of the outer bushing (11) and the outside wall of the inner bushing (10) carrying the teeter shaft (3).

27. The teeter bearing according to claim 21, wherein at least four to eight multilayered springs (4), in at least one plane perpendicular to the axis (3 or 1) are uniformly distributed around the inner bushing (10) carrying the shaft (3 or 1).

28. The teeter bearing according to claim 21, wherein at least four to eight multilayered springs (4) in a first plane perpendicular to the axis (3 or 1) and at least four to eight multilayered springs in a second plane, perpendicular to the axis (3 or 1), are uniformly distributed around the inner bushing (10) carrying the teeter shaft (3).

29. The teeter bearing according to claim 21, wherein the multilayered springs (4) are arranged on angle elements (13) which form an angle (α, β) to the teeter shaft (3) in such a way that axial and radial stiffness can be adjusted differently on tensioning of the elastic elements.

30. The teeter bearing according to claim 29, wherein the at least six to eight multilayered springs (4) of a plane have an angle (α, β) between 0 and 30° to the teeter shaft.

31. The teeter bearing according to claim 30, wherein the at least six to eight multilayered springs of a first plane have an angle (α) between 0 and 30° and at least six to eight multilayered springs of a second plane have an angle between 0 and 30° to the teeter shaft.

32. The teeter bearing according to claims 21, wherein the inner bushing (10) is formed by at least one terminal region of the shaft (3) or the outwardly directed terminal region of the main shaft (1), and this region is connected to the outer bushing (11) via the layer elements (4).

33. The teeter bearing according to claim 21, wherein the inner bushing (10) is attached as separate component to at least one terminal region of the shaft (3) or to the outwardly directed terminal region of the main shaft (1), and this region is connected to the outer bushing (11) via the layer elements (4).

34. The teeter bearing according to claim 32, wherein the inner bushing (10) is formed by the outwardly directed terminal region of the main shaft (1), or is attached to the outwardly directed terminal region of the main shaft (1), and the outer bushing (11) is formed by the rotor hub or a part of the rotor hub.

35. The teeter bearing according to claim 21, wherein at least one multilayered spring (4) has a hollow volume (14).

36. The teeter bearing according to claim 35, wherein a gas or a fluid is forced into or out of the hollow volume (14) of the at least one multilayered spring (4) by a hydraulic device (6, 7) in one or more or all multilayered spring elements (4), enabling the stiffness of the bearing to be changed specifically.

37. The teeter bearing according to claim 21, wherein at least one multilayered spring (4) has in its interior a fixed stop (101) in the form of a cylinder or cone corresponding to the outer shape of the multilayered spring element (4) in order to limit the potential deformation of the multilayered spring.

38. The teeter bearing according to claim 21, wherein the teetering bearing is used for adjustment of rotor blades or for the reduction, elimination and control of mass moments of inertia which are transmitted by the rotor blades of a one-, two- or multibladed wind turbine or of a helicopter or of a ship's propeller.

39. A rotor hub (8) for a one-, two- or multibladed rotor comprising a teeter bearing teeter bearing (9) comprising:
an inner bushing (10), which is able to accommodate the shaft or teeter shaft (3) or the main shaft for the teeter bearing, and
a surrounding outer bushing (11), which is connected to the inner bushing (10) and comprises tensionable elastic elements (4) which are built up from elastic layers and non-elastic interlayers,
wherein the elastic elements used are at least four multilayered springs (4) having a round or elliptical base shape, where the elastic elements (4) in the interior of the outer bushing (11) are arranged in a radial distribution around the inner bushing (10) and have tensioning devices (12), enabling the thickness of the elastic multilayered springs, and thus the pretensioning, to be adjusted and changed to the respective regions of the inner bushing and thus of the teeter shaft independently of one another,
fixing devices for the rotor blades, and
fixing devices for the shaft (3) or the shaft (1).

40. A one-, two- or multibladed wind turbine comprising a teeter bearing (9) teeter bearing (9) or a rotor hub (8) comprising:
an inner bushing (10), which is able to accommodate the shaft or teeter shaft (3) or the main shaft for the teeter bearing, and
a surrounding outer bushing (11), which is connected to the inner bushing (10) and comprises tensionable elastic elements (4) which are built up from elastic layers and non-elastic interlayers,
wherein the elastic elements used are at least four multilayered springs (4) having a round or elliptical base shape, where the elastic elements (4) in the interior of the outer bushing (11) are arranged in a radial distribution around the inner bushing (10) and have tensioning devices (12), enabling the thickness of the elastic muitilayered springs, and thus the pretensioning, to be adjusted and changed to the respective regions of the inner bushing and thus of the teeter shaft independently of one another.
